(19) United States
(12) Patent Application Publication
(10) Pub. No.: US 2025/0215732 A1
(43) Pub. Date: Jul. 3, 2025

(54) CASSETTE LATCH FOR TRUCK CANOPY

(71) Applicant: Lee WILKERSON, Stanwood, WA (US)

(72) Inventor: Lee WILKERSON, Stanwood, WA (US)

(21) Appl. No.: 18/981,482

(22) Filed: Dec. 14, 2024

Related U.S. Application Data
(60) Provisional application No. 63/617,251, filed on Jan. 3, 2024.

(51) Int. Cl. E05C 1/10

(52) U.S. Cl. CPC E05C 1/10

(57) ABSTRACT

The invention provides a latch for securing the rear hatch of a truck canopy. The latch attaches to the inside surface of the hatch and interfaces with the inside surface of the tailgate of a truck. The latch can automatically secure the canopy hatch by closing the hatch against the truck tailgate when the tailgate is closed, or by closing the tailgate against the canopy hatch when the hatch is in a closed position.

### CROSS-REFERENCE TO RELATED APPLICATIONS

The invention generally relates to canopies for pickup trucks. More particularly, the invention relates to a latch for securing the hatch of a canopy for a pickup truck.

### FIELD OF THE INVENTION

The invention generally relates to canopies for pickup trucks. More particularly, the invention relates to a latch for securing the hatch of a canopy for a pickup truck.

### BACKGROUND

Known latches for truck canopies maintain the canopy hatch in a closed position by interfacing with the body of the canopy. These latches are located on the canopy hatch and engage fittings on the sidewalls of the canopy. These latches can be in the form of a pair of rotating t-lock latches, or push-button latches, that are located on the lower corners of the canopy hatch. Alternatively, the hatch is secured with a single push-button or rotating latch in the lower, center of the hatch. However, none of these latches secure the hatch in a closed position by interfacing with the tailgate of a pick-up truck.

### SUMMARY OF THE INVENTION

The invention provides a cassette latch for securing the hatch of a truck canopy in a closed position by interfacing with the tailgate of a pickup truck. In general terms, the invention accomplishes this utility by incorporating a vertically sliding latch member that interfaces with a tailgate of a pickup truck when the tailgate is in a closed position. The latch member can be slidably disposed within a latch body comprising two sidewall members having at least one elongate slot. The latch member can incorporate a protruding stop that slides within the elongate slot. The protruding stop and elongate slots cooperate to provide a means for disengaging the latch member from the tailgate to permit the hatch to be opened.

The elongate slots and protruding stop also cooperate to hold the latch member in a maximum extended position when the hatch is in an open position. In the hatch's open position, the protruding stop abuts the bottom of the elongate slot under the tension of a spring located within the latch body and between the sidewall members. In this maximum extended position, the latch member is in a position to engage the tailgate when the hatch is closed. Alternatively, the hatch can be in a closed position such that closing the tailgate of the truck engages the latch member in its extended position thereby securing the hatch against the canopy body.

The inventive cassette latch also permits a user to unlatch the canopy hatch and tailgate in a single step. Known canopy latches require the tailgate and canopy to be unlatched individually by activation of their respective latches. The inventive latch, in contrast, permits the hatch to be unlatched automatically by unlatching and opening the tailgate. Conversely, the hatch can be secured in a closed position by simply closing the tailgate of the truck when the hatch is in its closed position. In addition, the hatch can be secured in a closed position by simply closing the hatch when the tailgate is in its closed position. Thus, the inventive latch permits a canopy hatch and tailgate to be latched in a single step.

### BRIEF DESCRIPTION OF THE DRAWINGS

FIG. 1 is a perspective view of an embodiment of the inventive cassette latch installed on the inside of a canopy hatch.

FIG. 2 is an internal view of an embodiment of the inventive cassette latch.

FIG. 3 is a perspective view of an embodiment of the inventive cassette latch with the internal components shown in broken lines.

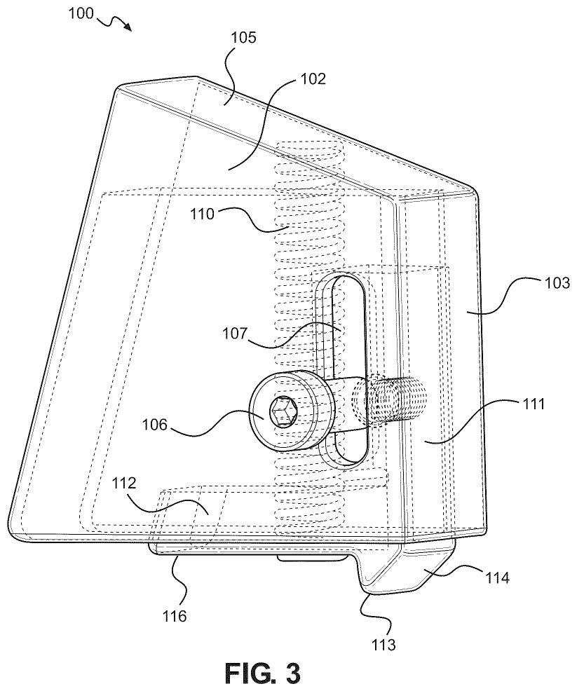

### DETAILED DESCRIPTION

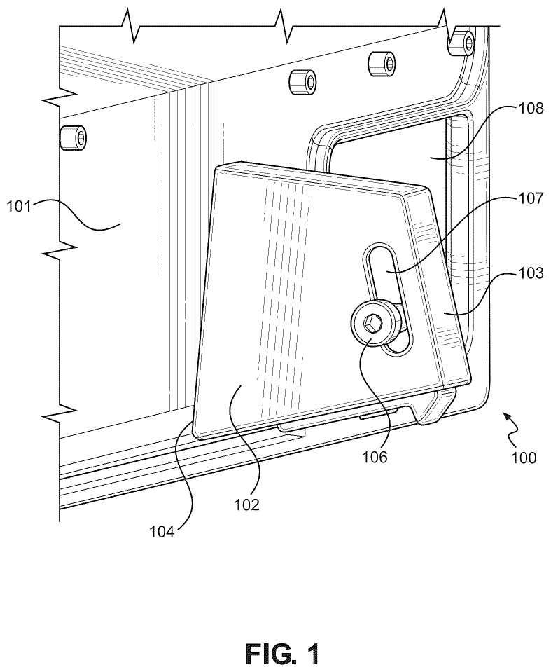

FIG. 1 shows an embodiment of the inventive cassette latch 100 secured to the inside surface of a canopy hatch 101. Cassette latch 100 can comprise a latch body comprising a pair of sidewalls 102, inward facing surface 103, connecting surface 104 and top surface 105. Cassette latch 100 can be secured to the inside surface of hatch 101 through connecting surface 104, by screws and/or an adhesive, for example. Latch stop 106 is slidably disposed within slot 107 which forms an aperture in sidewall 102. The cassette latch can feature latch stop 106 and slot 107 on one or both sides of the cassette latch, it being understood that sidewall 102, latch stop 106 and slot 107 will present themselves in a mirror image of the cassette latch shown in FIG. 1 on the opposing side of the latch. Latch stop 106 is connected to a latch member that is slidably disposed within the latch body between sidewall members 102. The latch body can be open on its bottom so as to permit the bottom of the latch member to engage the top of a tailgate of a pickup truck. Sidewalls 102 are positioned on opposing sides of a latch member slidably disposed within the latch body. Sidewalls 102 function to align the latch member within the latch body and guide the vertical travel of the latch member towards and away from the tailgate of a pickup truck. Sidewalls 102 can comprise a pair of opposing planar members.

Latch stop 106 is adapted to permit the latch member to be placed in a retracted state by a user grasping latch stop 106 and moving the latch member upward so as to disengage the latch member from the tailgate of a truck when the tailgate and canopy hatch are in a latched, closed position. As shown in FIG. 1, the latch member is in a partially retracted state as latch stop 106 is a distance away from the bottom of slot 107. That is, the latch member is not in a fully extended position as shown in FIG. 1. Placing the latch member in a retracted state permits the latch member to disengage from the tailgate of a truck thereby permitting the hatch of a canopy to be opened. As latch stop 106 and slot 107 can be located on both sides of the latch body, latch stop 106 can be used to open hatch 101 from the outside of the canopy by a user accessing latch stop 106 through an opening 108 in hatch 101.

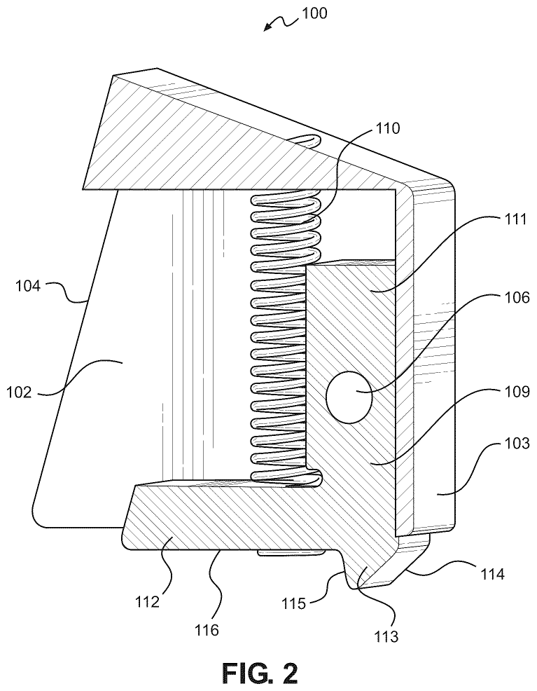

FIG. 2 shows the internal components of cassette latch 100, including latch member 109 and spring 110. Latch member 109 can comprise a vertically arranged first portion 111, a horizontally arranged second portion 112, and a tailgate engaging portion 113. Tailgate engaging portion 113 can include a first contacting surface 114 and a second contacting surface 115. As shown in FIG. 2, first contacting surface 114 and second contacting surface 115 can form an acute angle at the bottom of latch member 109. This angled shape permits latch 100 to assume a retracted state when hatch 101 is closed against the tailgate of a pickup truck. This occurs as first contact surface 113 contacts the outside top surface of the tailgate and is slidably compressed into the latch body against the resistance of spring 110 as hatch 101 is closed. Once the bottom of tailgate engaging portion 113 clears the back inside surface of the tailgate, spring 110 forces latch member 109 into an extended position such that second contacting surface 115 contacts the back inside surface of the tailgate under the force of spring 110 thereby securing hatch 101 in a closed position. With latch member 109 in an extended, locked position, latch member bottom 116 contacts the top surface of the tailgate to further stabilize latch member 109. In this closed position, latch stop 106 may, or may not, contact the bottom of slot 107. In a preferred embodiment, latch stop 106 does not contact the bottom of slot 107 so as to permit spring 110 to force latch member bottom 116 against the top surface of the tailgate.

In some aspects, spring 110 encircles a guide member that is connected to the top surface 105 of the latch body. The guide member can be a rigid or semi-rigid, elongate body that prevents spring 110 from bending or collapsing on itself during compression of spring 110. The guide member preferably has a diameter or cross-section that is less than the diameter or cross-section of the inside of spring 110 so as to permit the spring to travel over the guide member during compression and expansion of the spring. In embodiments including the guide member, second latch member portion 112 will include an opening to permit the guide member to traverse latch member 112 as the latch member moves upward towards top surface 105 of the latch body. The opening can be a countersunk hole having a larger diameter that receives spring 110 and a smaller diameter hole that is adapted to receive the guide member in a slidable relationship.

### REFERENCE NUMBERS

100—Cassette Latch
101—Canopy Hatch
102—Sidewall Members
103—Inward Facing Surface
104—Connecting Surface
105—Top Surface
106—Latch Stop
107—Slot
108—Hatch Opening
109—Latch Member
110—Spring
111—First Latch Member Portion
112—Second Latch Member Portion
113—Tailgate Engaging Portion
114—First Contacting Surface
115—Second Contacting Surface
116—Latch Member Bottom

1. A cassette latch for securing the hatch of a canopy, comprising:
a) a body comprising a pair of opposing sidewall members;
b) a latch member slidably disposed between the sidewall members; and
c) a spring in mechanical communication with the latch member.

2. The cassette latch of claim 1, wherein the latch member has an upper portion and a lower portion, and the lower portion comprises an extension adapted interface with a tailgate of pickup truck.

3. The cassette latch of claim 2, wherein the extension is arranged at an angle with respect to a bottom surface of the lower portion of the latch member.

4. The cassette latch of claim 1, wherein at least one of the opposing sidewall members comprises an opening.

5. The cassette latch of claim 4, wherein the latch member comprises an extension positioned within the opening.

6. The cassette latch of claim 5, wherein the extension abuts a bottom of the opening to maintain the latch member in an extended position.

7. The cassette latch of claim 6, wherein the extension abuts the bottom of the opening under the force of the spring.

8. The cassette latch of claim 1, wherein (i) the latch member comprises a first portion and a second portion, and (ii) the first portion is arranged at about a 90-degree angle with respect to the second portion.

9. The cassette latch of claim 8, wherein the spring has a longitudinal axis that is substantially parallel to a longitudinal axis of the first portion.

10. The cassette latch of claim 8, wherein the spring occupies a hole in an upper surface of the second portion.

11. The cassette latch of claim 1, wherein an elongate guide member is positioned within the spring.
